(19) United States
(12) Patent Application Publication
(10) Pub. No.: US 2026/0058726 A1
(43) Pub. Date: Feb. 26, 2026

(54) OPTICAL POWER DISTRIBUTION ESTIMATION APPARATUS, OPTICAL POWER DISTRIBUTION ESTIMATION METHOD, AND COMPUTER PROGRAM

(71) Applicant: NTT, Inc., Tokyo (JP)

(72) Inventors: Takeo SASAI, Musashino-shi (JP); Etsushi YAMAZAKI, Musashino-shi (JP); Hideki NISHIZAWA, Musashino-shi (JP); Yoshiaki SONE, Musashino-shi (JP); Yoshiaki KISAKA, Musashino-shi (JP)

(73) Assignee: NTT, Inc., Tokyo (JP)

(21) Appl. No.: 19/103,630

(22) PCT Filed: Sep. 13, 2022
(86) PCT No.: PCT/JP2022/034201

§ 371 Date: Feb. 13, 2025

(51) Int. Cl. H04B 10/079

(52) U.S. Cl. CPC H04B 10/07955

(57) ABSTRACT

An optical power distribution estimation device includes: a partial wavelength dispersion application unit that applies, to a signal, partial wavelength dispersion corresponding to a distance from an optical transmission device to an optical power measurement position; a nonlinear operation unit that performs, on the signal to which the partial wavelength dispersion has been applied, nonlinear operation using a linear term obtained by Taylor-expanding a mathematical expression used for phase rotation; a residual dispersion application unit that applies residual wavelength dispersion corresponding to a distance from the optical power measurement position to an optical reception device to the signal subjected to the nonlinear operation by the nonlinear operation unit; and a correlation calculation unit that estimates an optical power distribution of an optical transmission line by obtaining, for each optical power measurement position, a correlation between the signal to which the residual wavelength dispersion has been applied and a reception signal based on an optical signal transmitted from the optical transmission device and received via the optical transmission line.

### TECHNICAL FIELD

The present invention relates to an optical power distribution estimation device, an optical power distribution estimation method, and a computer program.

### BACKGROUND ART

When an optical transmission system is operated, basic characteristics of an optical fiber forming an optical transmission line greatly affect transmission performance. Here, the basic characteristics of the optical fiber include optical power, distributions of loss and dispersion, and a position of a fault point. For example, when the optical power is too large, an influence of a nonlinear optical effect in the optical fiber increases. Therefore, a signal-to-noise ratio (hereinafter, referred to as “SNR”) decreases. When the loss is too large, attenuation of the optical power increases accordingly, and the SNR decreases.

Therefore, it is important to know the characteristics of the optical fiber in operation, maintenance, and monitoring of the optical transmission system. The optical transmission line includes various devices in addition to the optical fiber, such as an optical amplifier and an optical filter. It is also important to know characteristics of those devices in operation, maintenance, and monitoring of the optical transmission system.

The characteristics of the optical fiber and the devices such as the optical amplifier and the optical filter can be generally measured by an analog measuring instrument such as an optical time domain reflectometer (OTDR) or an optical spectrum analyzer. However, in measurement using the analog measuring instrument, it is necessary to perform direct measurement on each optical node or each optical fiber, which increases an equipment cost and an operating cost.

In order to solve the above problem, digital longitudinal monitoring (DLM), which is a technique for detecting characteristics of various devices in the optical transmission system by digital signal processing on a reception side of the optical transmission system, has been proposed in recent years, instead of measurement using the analog measuring instrument (see, for example, Non Patent Literatures 1 and 2). The DLM is based on a digital coherent optical transmission system and performs digital signal processing on a reception signal obtained by performing coherent detection on an optical signal transmitted through the optical transmission line, thereby monitoring optical power or the like that is a characteristic of the optical transmission line.

Non Patent Literature 1 uses a method using a correlation, and the method will be referred to as a correlation method in the following description. FIG. 6 shows a configuration example of an optical reception device 10 using the correlation method for estimating an optical power distribution. The optical reception device 10 includes a coherent receiver 11, a demodulation decoding unit 12, a transmission signal restoration unit 13, a wavelength dispersion application unit 14, an absolute value calculation unit 15, and an optical power distribution estimation unit 16. The coherent receiver 11 receives an optical signal transmitted through the optical transmission line and performs coherent detection. The coherent receiver 11 outputs a reception signal obtained by the coherent detection to the demodulation decoding unit 12.

The demodulation decoding unit 12 decodes the reception signal output from the coherent receiver 11. The demodulation decoding unit 12 includes a wavelength dispersion compensation unit 121, a polarization fluctuation compensation unit 122, a frequency offset compensation unit 123, a carrier phase compensation unit 124, a symbol determination unit 125, and a decoding unit 126. The wavelength dispersion compensation unit 121 estimates wavelength dispersion received in the optical transmission line and compensates for the estimated wavelength dispersion with respect to the reception signal output from the coherent receiver 11. The polarization fluctuation compensation unit 122 compensates for distortion generated in a waveform of the reception signal in the optical transmission line by using the reception signal whose wavelength dispersion has been compensated for by the wavelength dispersion compensation unit 121.

The frequency offset compensation unit 123 compensates for a frequency offset with respect to the reception signal compensated by the polarization fluctuation compensation unit 122. The carrier phase compensation unit 124 compensates for a phase offset with respect to the reception signal whose frequency offset has been compensated for. The symbol determination unit 125 performs symbol determination on the reception signal whose phase offset has been compensated for. The decoding unit 126 decodes the reception signal on the basis of a result of the symbol determination by the symbol determination unit 125. The transmission signal restoration unit 13 restores a transmission signal by using the reception signal decoded by the demodulation decoding unit 12. The transmission signal restoration unit 13 includes a mapping unit 131 and a Nyquist filter 132. The mapping unit 131 maps the decoded reception signal. The Nyquist filter 132 restores a transmission signal by performing filter processing on the mapped reception signal.

The wavelength dispersion application unit 14 estimates wavelength dispersion received in the optical transmission line and applies a value of the estimated wavelength dispersion to the reception signal output from the polarization fluctuation compensation unit 122. Therefore, the reception signal is restored in which only the polarization fluctuation has been compensated for with respect to the signal output from the coherent receiver 11. The wavelength dispersion application unit 14 outputs the restored reception signal to the optical power distribution estimation unit 16. The absolute value calculation unit 15 takes an absolute value of the restored transmission signal and outputs the absolute value to the optical power distribution estimation unit 16.

The optical power distribution estimation unit 16 includes a partial wavelength dispersion compensation unit 161, a nonlinear operation unit 162, a residual dispersion compensation unit 163, an absolute value calculation unit 164, and a correlation calculation unit 165. The partial wavelength dispersion compensation unit 161 estimates partial wavelength dispersion corresponding to a distance from the optical reception device 10 to an optical power measurement position zₖ (k is a natural number of 0 or more) and compensates for the estimated partial wavelength dispersion with respect to the reception signal to which the value of the wavelength dispersion has been applied. The nonlinear operation unit 162 performs nonlinear operation in Equation (1) below on the reception signal whose partial wavelength dispersion has been compensated for by the partial wavelength dispersion compensation unit 161. In Equation (1), uₒᵤₜ denotes an output from the nonlinear operation unit 162, and uᵢₙ denotes the reception signal to which the value of the partial wavelength dispersion has been applied.

$$\begin{matrix}[ Math . 1 ] & \\ {u}_{out} = {u}_{in} \cdot exp ( - j ε ( {\vert {u}_{in , x} \vert}^{2} + {\vert {u}_{in , y} \vert}^{2} ) ) & Equation ( 1 )\end{matrix}$$

$$( {u}_{in} = [ \begin{matrix}{u}_{in , x} \\ {u}_{in , y}\end{matrix} ] , {u}_{out} = [ \begin{matrix}{u}_{out , x} \\ {u}_{out , y}\end{matrix} ] , ε is arbitrary real number set by user )$$

The residual dispersion compensation unit 163 estimates residual wavelength dispersion corresponding to a distance from the optical power measurement position zₖ to an optical transmission device and compensates for the estimated residual wavelength dispersion with respect to the reception signal subjected to the nonlinear operation. The absolute value calculation unit 164 takes an absolute value of the reception signal whose residual wavelength dispersion has been compensated for and outputs the absolute value to the correlation calculation unit 165. The correlation calculation unit 165 correlates the absolute value of the restored transmission signal output from the absolute value calculation unit 15 with the absolute value of the reception signal whose residual wavelength dispersion has been compensated for and which has been output from the absolute value calculation unit 164. The optical power distribution estimation unit 16 performs the above processing for all optical power measurement positions. An estimated power distribution obtained by plotting a correlation result obtained for each optical power measurement position by the correlation calculation unit 165 has a form of P₀ (offset)+aP(z). Here, a denotes a real number, and P(z) denotes estimated power for each position z.

### CITATION LIST

### Non Patent Literature

Non Patent Literature 1: T. Tanimura, et al., “Fiber-Longitudinal Anomaly Position Identification Over Multi-Span Transmission Link Out of Receiver-end Signals”, JLT, 38(9), 2020.
Non Patent Literature 2: T. Sasai, et al., “Digital longitudinal monitoring of Optical Fiber Communication Link”, JLT, 40(8), 2022.

### SUMMARY OF INVENTION

### Technical Problem

FIG. 7 is an explanatory diagram of a problem of optical power distribution estimation using a conventional correlation method. In a conventional configuration, the offset P₀ exists in an estimated power distribution, and thus, even if 10 log 10(P₀+aP(z)) of an estimated output is set as a logarithmic axis, a correct power level diagram (amount of power change) cannot be estimated as shown in FIG. 7. Further, in a case where the reception signal includes a large amount of noise, the noise is increased by performing nonlinear operation. As a result, estimation accuracy of the optical power distribution deteriorates.

As described above, in the conventional configuration, the amount of power change (dB) cannot be estimated because an unnecessary power offset exists in the estimated optical power distribution, and thus it is difficult to estimate an amount of loss.

In view of the above circumstances, an object of the present invention is to provide a technique capable of estimating an amount of power change.

### Solution to Problem

An aspect of the present invention is an optical power distribution estimation device including: a partial wavelength dispersion application unit that applies, to a signal, partial wavelength dispersion corresponding to a distance from an optical transmission device to an optical power measurement position; a nonlinear operation unit that performs, on the signal to which the partial wavelength dispersion has been applied, nonlinear operation using a linear term obtained by Taylor-expanding a mathematical expression used for phase rotation; a residual dispersion application unit that applies residual wavelength dispersion corresponding to a distance from the optical power measurement position to an optical reception device to the signal subjected to the nonlinear operation by the nonlinear operation unit; and a correlation calculation unit that estimates an optical power distribution of an optical transmission line by obtaining, for each optical power measurement position, a correlation between the signal to which the residual wavelength dispersion has been applied and a reception signal based on an optical signal transmitted from the optical transmission device and received via the optical transmission line.

An aspect of the present invention is an optical power distribution estimation method including: applying, to a signal, partial wavelength dispersion corresponding to a distance from an optical transmission device to an optical power measurement position; performing, on the signal to which the partial wavelength dispersion has been applied, nonlinear operation using a linear term obtained by Taylor-expanding a mathematical expression used for phase rotation; applying residual wavelength dispersion corresponding to a distance from the optical power measurement position to an optical reception device to the signal subjected to the nonlinear operation; and estimating an optical power distribution of an optical transmission line by obtaining, for each optical power measurement position, a correlation between the signal to which the residual wavelength dispersion has been applied and a reception signal based on an optical signal transmitted from the optical transmission device and received via the optical transmission line.

An aspect of the present invention is a computer program for causing a computer to execute: a partial wavelength dispersion application step of applying, to a signal, partial wavelength dispersion corresponding to a distance from an optical transmission device to an optical power measurement position; a nonlinear operation step of performing, on the signal to which the partial wavelength dispersion has been applied, nonlinear operation using a linear term obtained by Taylor-expanding a mathematical expression used for phase rotation; a residual wavelength dispersion application step of applying residual wavelength dispersion corresponding to a distance from the optical power measurement position to an optical reception device to the signal subjected to the nonlinear operation in the nonlinear operation step; and a correlation calculation step of estimating an optical power distribution of an optical transmission line by obtaining, for each optical power measurement position, a correlation between the signal to which the residual wavelength dispersion has been applied and a reception signal based on an optical signal transmitted from the optical transmission device and received via the optical transmission line.

### Advantageous Effects of Invention

According to the present invention, it is possible to estimate an amount of power change.

### BRIEF DESCRIPTION OF DRAWINGS

FIG. 1 A diagram illustrating a configuration example of an optical reception device according to a first embodiment.

FIG. 2 A flowchart showing a flow of processing of the optical reception device according to the first embodiment.

FIG. 3 A diagram illustrating a result of comparison between a method of the present invention and true power in an optical transmission line obtained by simulation.

FIG. 4 A diagram illustrating a configuration example of an optical reception device according to a modification example of the first embodiment.

FIG. 5 A diagram illustrating a configuration example of an optical transmission system according to a second embodiment.

FIG. 6 A diagram illustrating a configuration example of an optical reception device using a correlation method for estimating an optical power distribution.

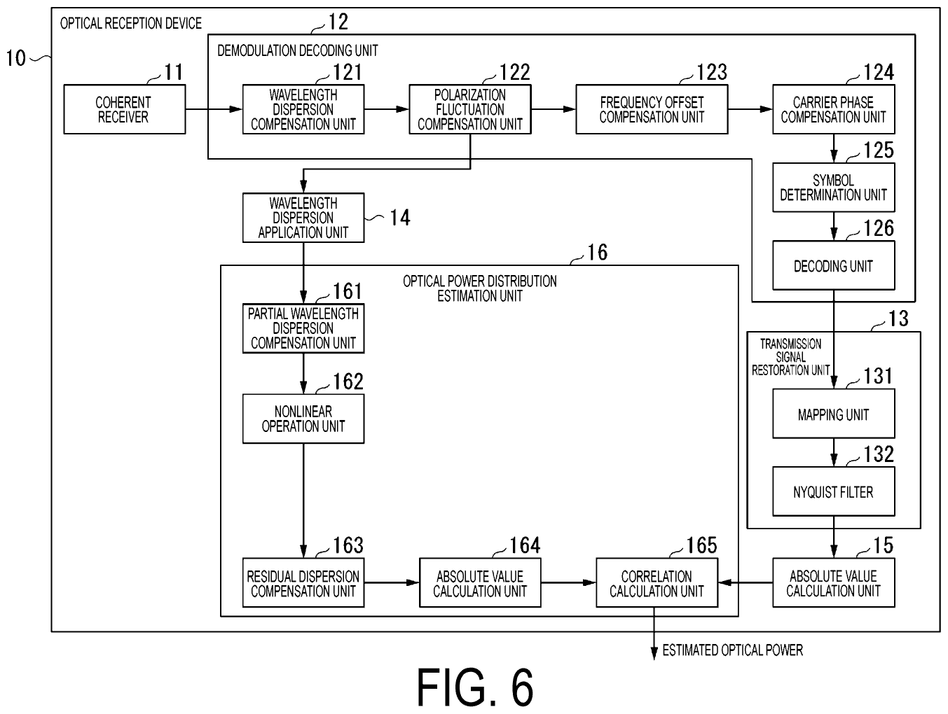

FIG. 7 An explanatory diagram of a problem of optical power distribution estimation using a conventional correlation method.

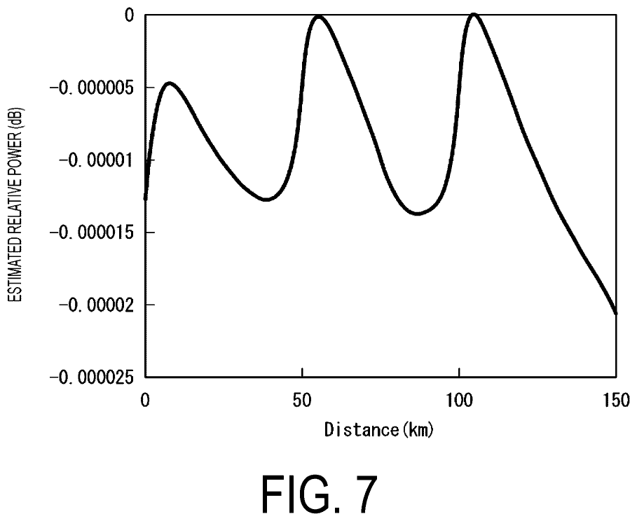

### DESCRIPTION OF EMBODIMENTS

Hereinafter, embodiments of the present invention will be described with reference to the drawings.

### First Embodiment

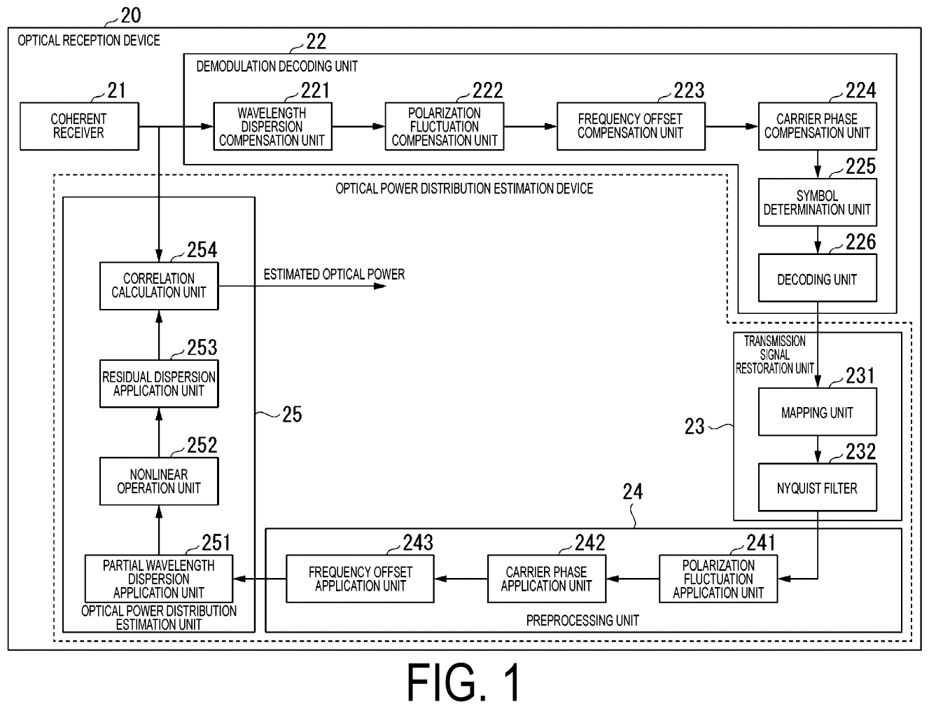

FIG. 1 shows a configuration example of an optical reception device 20 according to a first embodiment. The optical reception device 20 is connected to an optical transmission device included in an optical transmission system via an optical transmission line. The optical transmission line is, for example, an optical fiber. The optical reception device 20 receives a transmission signal transmitted from the optical transmission device via the optical transmission line. The optical reception device 20 includes a coherent receiver 21, a demodulation decoding unit 22, a transmission signal restoration unit 23, a preprocessing unit 24, and an optical power distribution estimation unit 25. Note that the transmission signal restoration unit 23, the preprocessing unit 24, and the optical power distribution estimation unit 25 are configured as an optical power distribution estimation device.

The coherent receiver 21 is connected to the optical transmission line and receives an optical signal (e.g. a transmission signal) transmitted through the optical transmission line to perform coherent detection. The coherent receiver 21 separates polarization of the received optical signal into X-polarization and Y-polarization. The coherent receiver 21 causes each of the X-polarization and Y-polarization optical signals after the polarization separation to interfere with laser light emitted from a local oscillation light source provided therein, thereby detecting the I-component and the Q-component of the X-polarization and the Y-polarization. The coherent receiver 21 converts the I-component and Q-component optical signals of the X-polarization and the Y-polarization into four series of analog electric signals. The coherent receiver 21 converts the converted four series of analog signals into four series of digital signals by using four analog-to-digital converters provided therein and outputs the four series of digital signals. Hereinafter, the four series of digital signals output from the coherent receiver 21 will be referred to as a reception signal.

The demodulation decoding unit 22 compensates for an influence caused by the optical transmission line with respect to the reception signal output from the coherent receiver 21 and decodes the reception signal. Examples of the influence caused by the optical transmission line include wavelength dispersion, polarization fluctuation, a frequency offset, and a carrier phase. The demodulation decoding unit 22 includes a wavelength dispersion compensation unit 221, a polarization fluctuation compensation unit 222, a frequency offset compensation unit 223, a carrier phase compensation unit 224, a symbol determination unit 225, and a decoding unit 226.

The wavelength dispersion compensation unit 221 estimates wavelength dispersion received in the optical transmission line and compensates for the estimated wavelength dispersion with respect to the reception signal output from the coherent receiver 21.

The polarization fluctuation compensation unit 222 compensates for distortion generated in a waveform of the reception signal in the optical transmission line by using the reception signal whose wavelength dispersion has been compensated for by the wavelength dispersion compensation unit 221. That is, the polarization fluctuation compensation unit 222 corrects a symbol error generated in the reception signal due to inter-symbol interference in the optical transmission line. For example, the polarization fluctuation compensation unit 222 may perform adaptive equalization processing by using a finite impulse response (FIR) filter according to a set tap coefficient. Note that the polarization fluctuation compensation unit 222 may compensate for the distortion generated in the waveform of the reception signal by a method other than the above which adaptively compensates for the polarization fluctuation.

The frequency offset compensation unit 223 executes processing of compensating for a frequency offset with respect to the reception signal compensated by the polarization fluctuation compensation unit 222.

The carrier phase compensation unit 224 executes processing of compensating for a phase offset with respect to the reception signal whose frequency offset has been compensated for.

The symbol determination unit 225 performs symbol determination on the reception signal whose phase offset has been compensated for.

The decoding unit 226 decodes the reception signal on the basis of a result of the symbol determination by the symbol determination unit 225.

The transmission signal restoration unit 23 restores the transmission signal by using the reception signal decoded by the demodulation decoding unit 22. That is, the transmission signal restoration unit 23 restores the transmission signal transmitted from the optical transmission device on the basis of the signal in which the influence caused by the optical transmission line has been compensated for. The transmission signal restoration unit 23 includes a mapping unit 231 and a Nyquist filter 232. The mapping unit 231 maps the decoded reception signal. The Nyquist filter 232 restores the transmission signal by performing filter processing on the mapped reception signal.

The preprocessing unit 24 performs predetermined processing on the transmission signal restored by the transmission signal restoration unit 23. Here, the predetermined processing is processing of applying a value corresponding to the influence caused by the optical transmission line to the transmission signal in order to bring the transmission signal close to the reception signal. The preprocessing unit 24 includes a polarization fluctuation application unit 241, a carrier phase application unit 242, and a frequency offset application unit 243.

The polarization fluctuation application unit 241 applies the same value as the distortion generated in the waveform of the reception signal compensated for by the polarization fluctuation compensation unit 222 to the transmission signal restored by the transmission signal restoration unit 23.

The carrier phase application unit 242 applies the same value as the phase offset compensated for by the carrier phase compensation unit 224 to the transmission signal to which the same value as the distortion has been applied by the polarization fluctuation application unit 241.

The frequency offset application unit 243 applies the same value as that of the frequency offset compensated for by the frequency offset compensation unit 223 to the transmission signal to which the same value as the phase offset has been applied by the carrier phase application unit 242.

As described above, the preprocessing unit 24 generates a signal in which a value of the wavelength dispersion has been removed from the reception signal received by the coherent receiver 21. Hereinafter, the transmission signal processed by the preprocessing unit 24 will be referred to as a preprocessed transmission signal.

The optical power distribution estimation unit 25 estimates an optical power distribution (optical transmission characteristic) of the optical transmission line by an estimation algorithm based on a correlation method. The optical power distribution estimation unit 25 includes a partial wavelength dispersion application unit 251, a nonlinear operation unit 252, a residual dispersion application unit 253, and a correlation calculation unit 254.

The partial wavelength dispersion application unit 251 applies a value of wavelength dispersion corresponding to a distance from the optical transmission device to an optical power measurement position zₖ to the preprocessed transmission signal. Hereinafter, the value of the wavelength dispersion corresponding to the distance from the optical transmission device to the optical power measurement position zₖ will be referred to as a partial wavelength dispersion value. For example, when k=10 is satisfied, the partial wavelength dispersion application unit 251 estimates the partial wavelength dispersion value corresponding to a distance from the optical transmission device to an optical power measurement position z₁₀ and applies the estimated partial wavelength dispersion value to the preprocessed transmission signal.

The lower limit of the optical power measurement position zₖ is, for example, a position (k=0) of the optical transmission device, and the upper limit of the optical power measurement position zₖ is, for example, a position of the optical reception device 20. The partial wavelength dispersion application unit 251 performs the above processing at all optical power measurement positions.

The nonlinear operation unit 252 performs nonlinear operation on the transmission signal to which the value of the partial wavelength dispersion has been applied by the partial wavelength dispersion application unit 251. More specifically, the nonlinear operation unit 252 performs nonlinear operation based on Equation (2) using a linear term obtained by Taylor-expanding a mathematical expression used for phase rotation on the transmission signal to which the value of the partial wavelength dispersion has been applied. Equation (2) is an equation using a linear term of the Taylor expansion of the conventional nonlinear operation unit 162. In Equation (2), uₒᵤₜ denotes an output from the nonlinear operation unit 252, and uᵢₙ denotes the transmission signal to which the value of the partial wavelength dispersion has been applied.

$$\begin{matrix}[ Math . 2 ] & \\ {u}_{out} = {u}_{in} \cdot ( - j ε ( {\vert {u}_{in , x} \vert}^{2} + {\vert {u}_{in , y} \vert}^{2} ) ) & Equation ( 2 )\end{matrix}$$

$$( {u}_{in} = [ \begin{matrix}{u}_{in , x} \\ {u}_{in , y}\end{matrix} ] , {u}_{out} = [ \begin{matrix}{u}_{out , x} \\ {u}_{out , y}\end{matrix} ] , ε is arbitrary real number set by user )$$

The residual dispersion application unit 253 applies a value of wavelength dispersion corresponding to a distance from the optical power measurement position zₖ to the optical reception device 20 to the transmission signal subjected to the nonlinear operation. Thus, the residual dispersion application unit 253 applies a value of wavelength dispersion corresponding to a remaining distance for which no value has been applied by the partial wavelength dispersion application unit 251. Hereinafter, the value of the wavelength dispersion corresponding to the distance from the optical power measurement position zₖ to the optical reception device 20 will be referred to as a residual wavelength dispersion value.

The correlation calculation unit 254 correlates the reception signal output from the coherent receiver 21 with the transmission signal to which the residual wavelength dispersion value has been applied and which has been output from the residual dispersion application unit 253. The correlation calculation unit 254 performs this processing for each optical power measurement position. The correlation calculation unit 254 estimates an estimated power distribution by plotting a correlation result (correlation value) obtained for each optical power measurement position.

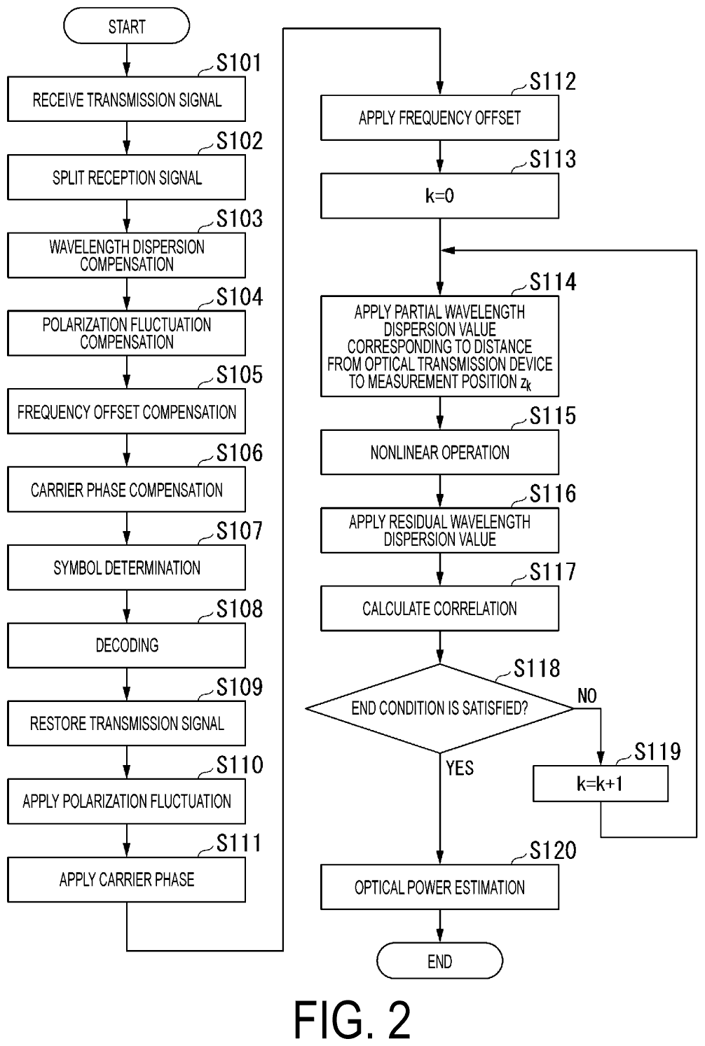

FIG. 2 is a flowchart showing a flow of processing of the optical reception device 20 according to the first embodiment.

The coherent receiver 21 receives a transmission signal transmitted from the optical transmission device via the optical transmission line (step S101). The coherent receiver 21 outputs the received reception signal. The reception signal output from the coherent receiver 21 is split and input to the demodulation decoding unit 22 and the optical power distribution estimation unit 25 (step S102).

The wavelength dispersion compensation unit 221 estimates wavelength dispersion received in the optical transmission line and compensates for the estimated wavelength dispersion with respect to the reception signal output from the coherent receiver 21 (step S103). The wavelength dispersion compensation unit 221 outputs the reception signal whose wavelength dispersion has been compensated for to the polarization fluctuation compensation unit 222. The polarization fluctuation compensation unit 222 compensates for distortion generated in a waveform of the reception signal in the optical transmission line by using the reception signal whose wavelength dispersion has been compensated for and which has been output from the wavelength dispersion compensation unit 221 (step S104). The polarization fluctuation compensation unit 222 outputs the compensated reception signal to the frequency offset compensation unit 223.

The frequency offset compensation unit 223 compensates for a frequency offset with respect to the reception signal compensated by the polarization fluctuation compensation unit 222 (step S105). The frequency offset compensation unit 223 outputs the reception signal whose frequency offset has been compensated for to the carrier phase compensation unit 224. The carrier phase compensation unit 224 compensates for a phase offset with respect to the reception signal whose frequency offset has been compensated for by the frequency offset compensation unit 223 (step S106). The carrier phase compensation unit 224 outputs the reception signal whose phase offset has been compensated for to the symbol determination unit 225.

The symbol determination unit 225 performs symbol determination on the reception signal whose phase offset has been compensated for (step S107). The symbol determination unit 225 outputs a result of the symbol determination to the decoding unit 226. The decoding unit 226 decodes the reception signal on the basis of the result of the symbol determination by the symbol determination unit 225 (step S108). The decoding unit 226 outputs the decoded reception signal to the transmission signal restoration unit 23.

The transmission signal restoration unit 23 restores the transmission signal by using the reception signal decoded by the demodulation decoding unit 22 (step S109). The transmission signal restoration unit 23 outputs the restored transmission signal to the preprocessing unit 24. The polarization fluctuation application unit 241 applies the same value as the distortion generated in the waveform of the reception signal compensated for by the polarization fluctuation compensation unit 222 to the transmission signal restored by the transmission signal restoration unit 23 (step S110). The polarization fluctuation application unit 241 outputs the transmission signal after the application to the carrier phase application unit 242.

The carrier phase application unit 242 applies the same value as the phase offset compensated for by the carrier phase compensation unit 224 to the transmission signal after the application, which is output from the polarization fluctuation application unit 241 (step S111). The carrier phase application unit 242 outputs the transmission signal after the application to the frequency offset application unit 243. The frequency offset application unit 243 applies the same value as that of the frequency offset compensated for by the frequency offset compensation unit 223 to the transmission signal after the application, which is output from the carrier phase application unit 242 (step S112). The frequency offset application unit 243 outputs the transmission signal after the application to the optical power distribution estimation unit 25.

The partial wavelength dispersion application unit 251 sets k=0 (step S113) and estimates a value of wavelength dispersion corresponding to a distance from the optical transmission device to the optical power measurement position zₖ. For example, k=0 is satisfied in step S113, and thus, here, the partial wavelength dispersion application unit 251 estimates a partial wavelength dispersion value that is a value of wavelength dispersion corresponding to a distance from the optical transmission device to an optical power measurement position z₀. The partial wavelength dispersion application unit 251 applies the estimated partial wavelength dispersion value to the transmission signal after the application, which is output from the frequency offset application unit 243 (step S114). The partial wavelength dispersion application unit 251 outputs the transmission signal to which the partial wavelength dispersion value has been applied to the nonlinear operation unit 252.

The nonlinear operation unit 252 performs nonlinear operation based on Equation (2) above by using the transmission signal after the application of the partial wavelength dispersion value, which is output from the partial wavelength dispersion application unit 251 (step S115). The nonlinear operation unit 252 outputs the transmission signal subjected to the nonlinear operation to the residual dispersion application unit 253. The residual dispersion application unit 253 estimates a value of wavelength dispersion corresponding to a distance from the optical power measurement position zₖ to the optical reception device 20. For example, the residual dispersion application unit 253 estimates a residual wavelength dispersion value that is a value of wavelength dispersion corresponding to a distance from the optical power measurement position z₀ to the optical reception device 20. The residual dispersion application unit 253 applies the estimated residual wavelength dispersion value to the transmission signal subjected to the nonlinear operation and output from the nonlinear operation unit 252 (step S116). The residual dispersion application unit 253 outputs the transmission signal to which the residual wavelength dispersion value has been applied to the correlation calculation unit 254.

The correlation calculation unit 254 correlates the reception signal output from the coherent receiver 21 with the transmission signal after the application of the residual wavelength dispersion value, which is output from the residual dispersion application unit 253 (step S117). Thereafter, the correlation calculation unit 254 determines whether or not an end condition is satisfied (step S118). Here, the end condition is a condition for ending calculation of the correlation and may be, for example, that the calculation of the correlation from all the optical power measurement positions is completed.

When determining that the end condition is not satisfied (step S118: NO), the correlation calculation unit 254 adds a value 1 to k (step S119). Thereafter, the optical reception device 20 repeatedly executes the processing in step S114 and subsequent steps. For example, when the added value is k=1, the partial wavelength dispersion application unit 251 estimates a value of partial wavelength dispersion corresponding to a distance from the optical transmission device to an optical power measurement position z₁ in the processing of step S114. The partial wavelength dispersion application unit 251 applies the estimated partial wavelength dispersion value to the transmission signal after the application, which is output from the frequency offset application unit 243.

Thereafter, the processing from steps S115 to S117 is executed with k=1. Thereafter, the correlation calculation unit 254 determines whether or not the end condition is satisfied again (step S118). As described above, the processing from step S114 to step S117 is repeatedly executed until the correlation is acquired at all the optical power measurement positions.

In the processing of step S118, when determining that the end condition is satisfied (step S118—YES), the correlation calculation unit 254 performs optical power estimation by using the correlation result acquired for each optical power measurement position (step S120). Specifically, the correlation calculation unit 254 estimates an estimated power distribution by plotting the correlation result acquired for each optical power measurement position. At this time, the estimated power output from the correlation calculation unit 254 is a complex value. When plotting, the correlation calculation unit 254 takes a real part of the estimated power or takes an absolute value and then performs plotting.

Under the following conditions, true power in the optical transmission line was obtained by simulation, and the obtained true power in the optical transmission line was compared with the method of the present invention.

### (Simulation Conditions)

Transmission line model: Split-step Fourier method
SSFM dz: 0.05 km
Oversampling rate: 40 samples/symbol
Loss factor: 0.2 dB/km
Wavelength dispersion coefficient: D=16 ps/nm/km
Nonlinear coefficient: g=1.3 W⁻¹ km⁻¹
Signal: Probabilistically-shaped 64QAM64 GBd
Measurement interval: 0.25 km

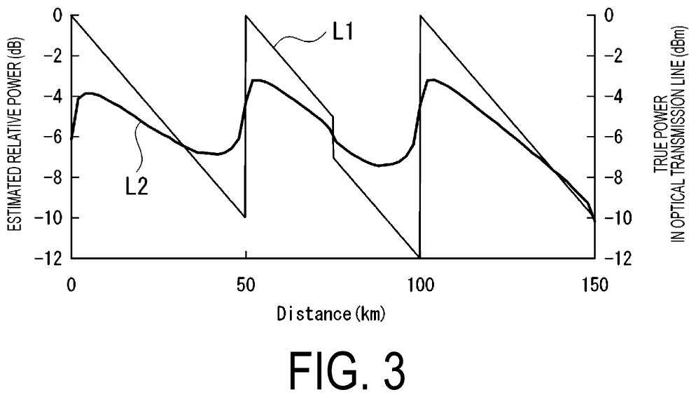

FIG. 3 shows a result of comparison between the method of the present invention and the true power in the optical transmission line obtained by the simulation. In FIG. 3, L1 indicates the true power in the optical transmission line set in the simulation, and L2 indicates relative power obtained by the method of the present invention. FIG. 3 shows that a value close to a correct power level diagram (amount of power change dB) can be estimated by setting 10 log 10(P(z)) of an estimated output as a logarithmic axis. That is, the result in FIG. 3 indicates that the method of the present invention can estimate an amount of true power change (dB) (can estimate a physically meaningful value).

The optical reception device 20 configured as described above includes: the partial wavelength dispersion application unit 251 that applies, to a signal, partial wavelength dispersion corresponding to a distance from an optical transmission device to an optical power measurement position; the nonlinear operation unit 252 that performs, on the signal to which the partial wavelength dispersion has been applied, nonlinear operation (Equation (2) above) using a linear term obtained by Taylor-expanding a mathematical expression used for phase rotation; a residual dispersion application unit 253 that applies residual wavelength dispersion corresponding to a distance from the optical power measurement position to the optical reception device 20 to the signal subjected to the nonlinear operation; and a correlation calculation unit 254 that estimates an optical power distribution of an optical transmission line by obtaining, for each optical power measurement position, a correlation between the signal to which the residual wavelength dispersion has been applied and a reception signal based on an optical signal transmitted from the optical transmission device and received via the optical transmission line. In the conventional configuration, Equation (1) is used for the nonlinear operation, and an offset P₀ is generated due to a constant term (=1) when exp in Equation (1) is Taylor-expanded. As a result, the amount of power change cannot be estimated. Meanwhile, in the optical reception device 20, only the linear term Taylor-expanded as shown in Equation (2) is used for the nonlinear operation, and the constant term is deleted. Thus, the offset P₀ can be cancelled. As a result, the amount of power change can be estimated.

Further, in the conventional configuration, the nonlinear operation is performed on the reception signal. When noise is denoted by N and an x-polarization signal is indicated by u_{in.x}=u_{in.x_true}+N, |u_{in.x}|²=|u_{in,x_true}|²+|N|²+u*_{in.x_true}N+u_{in.x_true}N*holds, and phase rotation is excessively performed by the amount of noise (the same applies to y-polarization). Meanwhile, in the optical reception device 20, the nonlinear operation is performed on the restored transmission signal, and thus no noise N exists in the signal. Therefore, |u_{in.x}|²=|u_{in.x_true}|² holds, and an excessive component does not appear. This makes it possible to improve estimation accuracy of the optical power distribution.

### Modification Example 1

The order of the compensation by the demodulation decoding unit 22 and the order of the application by the preprocessing unit 24 and the optical power distribution estimation unit 25 are not limited to the above orders. The order of the compensation by the demodulation decoding unit 22 may be any order. The above embodiment shows a configuration in which the values corresponding to the polarization fluctuation, the frequency offset, and the carrier phase are applied to the restored transmission signal in the preprocessing unit 24, but the values corresponding to the polarization fluctuation, the frequency offset, and the carrier phase only need to be applied before the processing is performed by the correlation calculation unit 254.

### Modification Example 2

In the above embodiment, the processing of taking an absolute value may be performed before the correlation calculation is performed as in the related art.

### Modification Example 3

The above embodiment shows a configuration in which the preprocessing unit 24 applies, to the restored transmission signal, the values corresponding to the polarization fluctuation, the frequency offset, and the carrier phase applied in the optical transmission line to the transmission signal transmitted from the optical transmission device. In the optical reception device 20, the same amount only needs to be added to two waveforms to be subjected to correlation calculation. Therefore, the optical reception device 20 may use a method of applying the same amount as an amount added to the reception signal to the restored transmission signal or a method of performing compensation from the reception signal. The method of performing compensation from the reception signal is a method of using, in the correlation calculation unit 254, the signal in which the influence caused by the optical transmission line has been compensated for with respect to the reception signal.

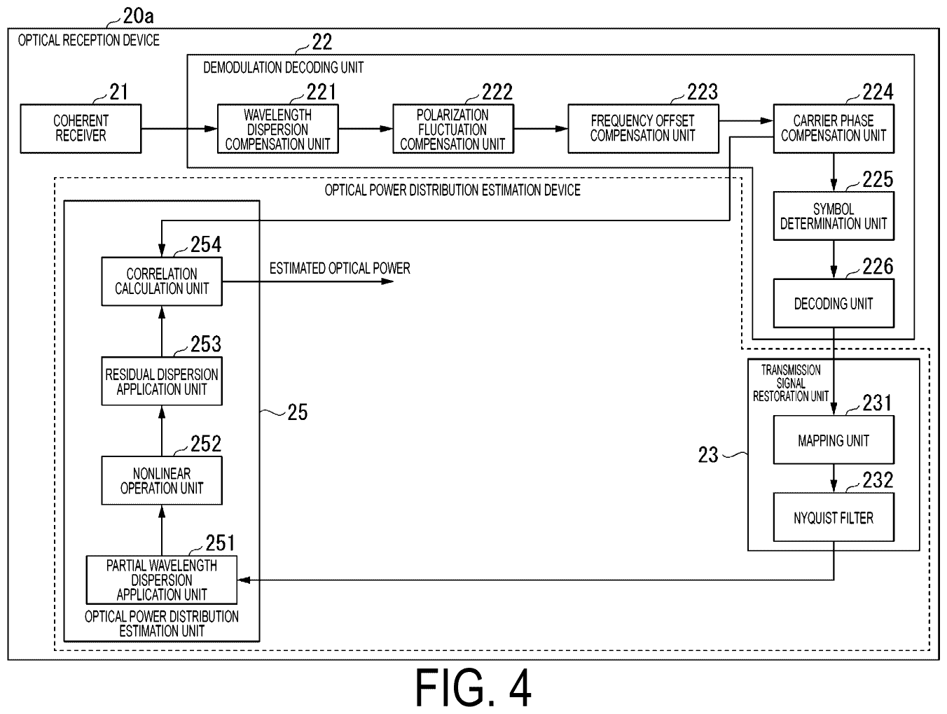

FIG. 4 shows a configuration example of an optical reception device 20a according to a modification example of the first embodiment. The optical reception device 20a receives a transmission signal transmitted from an optical transmission device connected via an optical transmission line. The optical reception device 20a includes the coherent receiver 21, the demodulation decoding unit 22, the transmission signal restoration unit 23, and the optical power distribution estimation unit 25. The optical reception device 20a is different from the optical reception device 20 in not including the preprocessing unit 24. Hereinafter, processing different from that of the optical reception device 20 will be described.

The optical reception device 20a outputs a reception signal whose phase offset has been compensated for by the carrier phase compensation unit 224 also to the optical power distribution estimation unit 25. The optical reception device 20a further outputs the transmission signal restored by the transmission signal restoration unit 23 to the optical power distribution estimation unit 25. The optical power distribution estimation unit 25 performs processing similar to the processing described in the above embodiment on the restored transmission signal. The correlation calculation unit 254 correlates the reception signal output from the demodulation decoding unit 22 with the transmission signal after the application of the residual wavelength dispersion value, which is output from the residual dispersion application unit 253. The correlation calculation unit 254 repeatedly executes this processing until the end condition is satisfied.

### Second Embodiment

In a second embodiment, there will be described a configuration in which optical power distribution estimation processing is performed in a network controller that manages an optical transmission system.

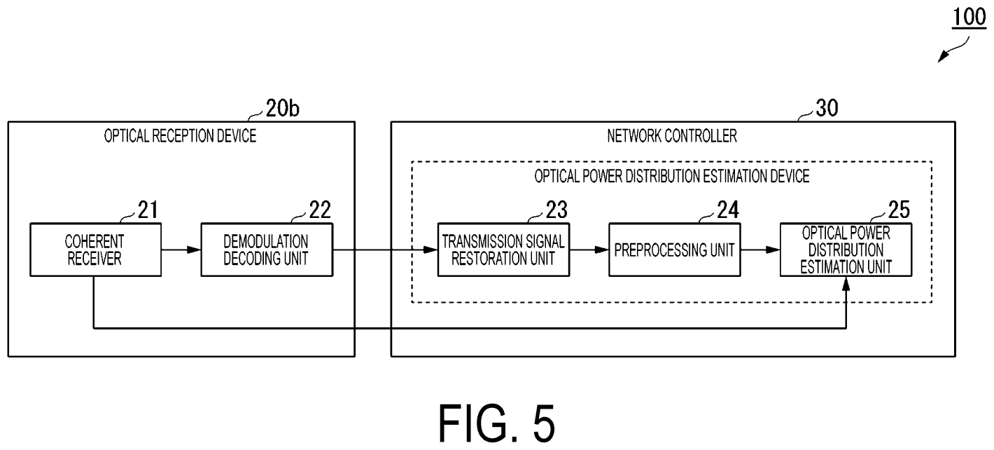

FIG. 5 shows a configuration example of an optical transmission system 100 according to the second embodiment. The optical transmission system 100 includes an optical transmission device (not shown), an optical reception device 20b, and a network controller 30. The optical transmission system 100 may include a plurality of optical reception devices 20b. The optical transmission device (not shown) and the optical reception device 20b are connected by an optical transmission line, and the optical reception device 20b and the network controller 30 are connected by an electric line. The optical reception device 20b receives a transmission signal transmitted from the optical transmission device connected via the optical transmission line. The network controller 30 is a host device that manages the optical transmission system 100.

The optical reception device 20b includes the coherent receiver 21 and the demodulation decoding unit 22. The network controller 30 includes the transmission signal restoration unit 23, the preprocessing unit 24, and the optical power distribution estimation unit 25. Processing performed by the coherent receiver 21, the demodulation decoding unit 22, the transmission signal restoration unit 23, the preprocessing unit 24, and the optical power distribution estimation unit 25 is basically the same as that in the first embodiment. Hereinafter, differences from the first embodiment will be described.

The coherent receiver 21 outputs a reception signal to the demodulation decoding unit 22 and also to the optical power distribution estimation unit 25 included in the network controller 30 via the electric line. The demodulation decoding unit 22 outputs the decoded reception signal to the transmission signal restoration unit 23 included in the network controller 30 via the electric line.

Each functional unit included in the network controller 30 performs processing similar to that in the first embodiment.

According to the optical transmission system 100 configured as described above, the network controller 30 serving as a host device that manages the optical transmission system 100 estimates an optical power distribution. This makes it possible to reduce a processing load of one optical reception device 20b.

Further, in a case where a plurality of optical reception devices 20b is connected to the network controller 30, the network controller 30 can estimate the optical power distribution for each optical reception device 20b. Therefore, it is unnecessary to estimate the optical power distribution in each optical reception device 20b, and thus each optical reception device 20b does not need to have a function of estimating the optical power distribution. Further, one network controller 30 estimates the optical power distributions for the plurality of optical reception devices 20b, and thus it is possible to efficiently estimate the optical power distributions. In a case where the optical reception devices 20b receive signals having different wavelengths (i.e. in a case of wavelength division multiplexing: WDM system), wavelength dependency of the optical power distributions obtained by the present invention can be acquired. This makes it possible to acquire wavelength dependency of loss of the optical fiber in the optical transmission system, a gain spectrum of an optical amplifier, and the like.

### Modification Example 1

The second embodiment may be modified in a similar way to the first to third modification examples of the first embodiment. For example, in a case where the network controller 30 is configured as in (Modification Example 3), the network controller 30 only needs to acquire the same amount of information as an amount added to the reception signal from the optical reception device 20b. Further, the network controller 30 does not include the preprocessing unit 24 in a case of the method of performing compensation from the reception signal and acquires the reception signal whose carrier phase has been compensated from the optical reception device 20b.

### Application Example of Present Invention

The present invention can be applied to estimation of various optical transmission line characteristics. When this power distribution estimation is performed on optical signals having various wavelengths, it is possible to estimate an optical power distribution (abnormal fiber detection), estimate a gain spectrum and gain tilt of the optical amplifier (abnormal amplifier detection), estimate a power distribution in a distance direction+a wavelength direction in the optical transmission line, and estimate multipath interference. Further, when the optical power distribution is acquired in both the X-polarization and the Y-polarization, it is possible to estimate an amount and position of polarization-dependent loss (PDL).

Some or all of the functional units of the optical reception devices 20, 20a, and 20b and the network controller 30 described above are implemented as software by causing a processor such as a central processing unit (CPU) to execute a program stored in a storage device including a nonvolatile recording medium (non-transitory recording medium) and a storage unit. The program may be recorded in a computer-readable non-transitory recording medium. The computer-readable non-transitory recording medium is a non-transitory recording medium such as a portable medium including, for example, a flexible disk, a magneto-optical disk, a read only memory (ROM), and a compact disc read only memory (CD-ROM) or a storage device such as a hard disk built in a computer system.

Some or all of the functional units of the optical reception devices 20, 20a, and 20b and the network controller 30 described above may be implemented by using hardware including an electronic circuit (or circuitry) including, for example, a large scale integrated circuit (LSI), an application specific integrated circuit (ASIC), a programmable logic device (PLD), or a field programmable gate array (FPGA).

Although the embodiments of the present invention have been described in detail with reference to the drawings, specific configurations are not limited to the embodiments and include design and the like within the gist of the present invention.

### INDUSTRIAL APPLICABILITY

The present invention can be applied to a technique of estimating transmission characteristics in a digital coherent optical transmission system.

### REFERENCE SIGNS LIST

20, 20a, 20b Optical reception device
21 Coherent receiver
22 Demodulation decoding unit
23 Transmission signal restoration unit
24 Preprocessing unit
25 Optical power distribution estimation unit
30 Network controller
221 Wavelength dispersion compensation unit
222 Polarization fluctuation compensation unit
223 Frequency offset compensation unit
224 Carrier phase compensation unit
225 Symbol determination unit
226 Decoding unit
231 Mapping unit
232 Nyquist filter
241 Polarization fluctuation application unit
242 Carrier phase application unit
243 Frequency offset application unit
251 Partial wavelength dispersion application unit
252 Nonlinear operation unit
253 Residual dispersion application unit
254 Correlation calculation unit

1. An optical power distribution estimation device comprising:
a partial wavelength dispersion applicator configured to apply, to a signal, partial wavelength dispersion corresponding to a distance from an optical transmission device to an optical power measurement position;
a nonlinear operator configured to perform, on the signal to which the partial wavelength dispersion has been applied, nonlinear operation using a linear term obtained by Taylor-expanding a mathematical expression used for phase rotation;
a residual dispersion applicator configured to apply residual wavelength dispersion corresponding to a distance from the optical power measurement position to an optical reception device to the signal subjected to the nonlinear operation by the nonlinear operator; and
a correlation calculator configured to estimate an optical power distribution of an optical transmission line by obtaining, for each optical power measurement position, a correlation between the signal to which the residual wavelength dispersion has been applied and a reception signal based on an optical signal transmitted from the optical transmission device and received via the optical transmission line.

2. The optical power distribution estimation device according to claim 1, further comprising
a transmission signal restore configured to restore a transmission signal transmitted by the optical transmission device on a basis of the reception signal, wherein
the partial wavelength dispersion applicator applies the partial wavelength dispersion to the restored transmission signal or a signal obtained by performing predetermined processing on the restored transmission signal.

3. The optical power distribution estimation device according to claim 2, further comprising
a preprocessor configured to perform the predetermined processing on the transmission signal restored by the transmission signal restorer, wherein:
the reception signal is a signal in which an influence caused by the optical transmission line has not been compensated for;
the transmission signal restorer restores the transmission signal on a basis of a signal in which the influence caused by the optical transmission line has been compensated for; and
as the predetermined processing, the preprocessor applies a value corresponding to the influence caused by the optical transmission line in order to bring the transmission signal close to the reception signal.

4. The optical power distribution estimation device according to claim 2, wherein:
the reception signal is a signal in which an influence caused by the optical transmission line has been compensated for;
the transmission signal restorer restores the transmission signal on a basis of the signal in which the influence caused by the optical transmission line has been compensated for; and
the partial wavelength dispersion applicator applies the partial wavelength dispersion to the restored transmission signal.

5. An optical power distribution estimation method comprising:
applying, to a signal, partial wavelength dispersion corresponding to a distance from an optical transmission device to an optical power measurement position;
performing, on the signal to which the partial wavelength dispersion has been applied, nonlinear operation using a linear term obtained by Taylor-expanding a mathematical expression used for phase rotation;
applying residual wavelength dispersion corresponding to a distance from the optical power measurement position to an optical reception device to the signal subjected to the nonlinear operation; and
estimating an optical power distribution of an optical transmission line by obtaining, for each optical power measurement position, a correlation between the signal to which the residual wavelength dispersion has been applied and a reception signal based on an optical signal transmitted from the optical transmission device and received via the optical transmission line.

6. A non-transitory storage medium that stores a program for making a computer perform processes, the processes comprising:
applying, to a signal, partial wavelength dispersion corresponding to a distance from an optical transmission device to an optical power measurement position;
performing, on the signal to which the partial wavelength dispersion has been applied, nonlinear operation using a linear term obtained by Taylor-expanding a mathematical expression used for phase rotation;
applying residual wavelength dispersion corresponding to a distance from the optical power measurement position to an optical reception device to the signal subjected to the nonlinear operation; and
estimating an optical power distribution of an optical transmission line by obtaining, for each optical power measurement position, a correlation between the signal to which the residual wavelength dispersion has been applied and a reception signal based on an optical signal transmitted from the optical transmission device and received via the optical transmission line.
